(19) United States
(12) Patent Application Publication
(10) Pub. No.: US 2026/0294707 A1
(43) Pub. Date: Oct. 1, 2026

(54) A Locking Hinge

(71) Applicant: Rolapal Limited, Auckland (NZ)

(72) Inventor: Roydon Scarlett, Auckland (NZ)

(21) Appl. No.: 18/996,530

(22) PCT Filed: Jul. 5, 2023
(86) PCT No.: PCT/NZ2023/050067

§ 371 Date: Jan. 17, 2025

(30) Foreign Application Priority Data
Aug. 29, 2022 (AU) 2022223050

(51) Int. Cl. A61G 5/12

(52) U.S. Cl. CPC A61G 5/122; A61G 2203/70

(57) ABSTRACT

Wheelchairs have lateral pads for supporting the sides of the human user's torso. The pads can be swung out of the way to enable the user easy access, and then swung back closer to the body and locked in place. The locking hinge is a lateral support forming part of a seat, comprising a hinge plate, a hinge pin, a swivel plate, a swivel pin and a release lever. They are arranged such that the swivel plate is adapted to rotate about the hinge pin with respect to the hinge plate. The release lever is adapted to rotate about the swivel pin with respect to the swivel plate such that an interference surface of the release lever takes up a locking position immediately next to an interference surface of the hinge pin. In the locking position the two interference surfaces present a rotation impasse to one another.

### FIELD OF THE INVENTION

This invention relates to a locking hinge.

### BACKGROUND

It is known for wheelchairs to have lateral pads for supporting the sides of the torso of a human user. It is convenient for the pads to be swung out of the way to enable the user easy access to the chair, and then swung back closer to the body and locked in place. It is an object of a preferred form of the invention to go at least some way towards achieving this. However, it should be understood that the invention has more general applicability and that any objects or advantages of the preferred embodiment should not be seen as a limitation on the claims.

### DEFINITIONS

The term “comprising” if and when used in this document in relation to a combination of features should not be seen as excluding the option of additional unspecified features or steps. In other words, the term should not be interpreted in a limiting way. The term “compartment” also includes pocket spaces.

### SUMMARY OF INVENTION

According to one aspect, the invention is a wheelchair comprising a lateral support adapted to provide postural support to the torso of a person when seated in the wheelchair, the lateral support comprising a hinge plate, a hinge pin, a swivel plate, a swivel pin and a release lever, arranged such that:
the swivel plate is adapted to rotate about the hinge pin with respect to the hinge plate;
the release lever is adapted to rotate about the swivel pin with respect to the swivel plate such that:
   an interference surface of the release lever takes up a locking position immediately next to an interference surface of the hinge pin; wherein
   in the locking position the two interference surfaces present a rotational impasse with respect to one another.

Optionally the hinge pin and the swivel pin are substantially parallel to one another.

Optionally central longitudinal axis of the swivel pin is aligned with, or slightly inside, the most outward edge of the hinge pin such that when the release lever is in the locking position the outer edge of that lever clashes with the hinge pin.

Optionally a first side of the release lever is adapted to be pressed by hand inwards, so as to rotate the lever out of the locking position.

Optionally a second side of the release lever, being opposite said first side, can be pulled by hand to rotate the lever out of the locking position.

Optionally the lever is adapted to be pressed inwards with respect to the swivel plate to rotate the lever into the locking position.

Optionally the interference surface of the hinge pin comprises a recess extending longitudinally along that pin and the interference surface of the release lever fits snugly within said recess.

Optionally the recess is substantially planar.

Optionally the hinge plate is generally ‘U’shaped.

Optionally the release lever has a rounded protrusion that is adapted to fit into a complementary curved recess of the swivel plate immediately adjacent to the hinge pin, the protrusion providing a finger or thumb button surface arranged such that, when pressed by hand, the lever moves out of its locking position.

Optionally the hinge plate is fixed such that it does not rotate, rather the swivel plate is rotatable with respect to it.

Optionally the release lever incorporates a spring which biases that lever towards the locking position.

### BRIEF DESCRIPTION OF THE DRAWINGS

Some preferred forms of the invention will now be described by way of example and with reference to the accompanying drawings, of which:

FIG. 1 is an isometric view of a wheelchair incorporating a lateral support;

FIG. 2 is an isometric view of the lateral support, less its padding, when in a locked disposition;

FIG. 3 is an isometric view of the lateral support, less its padding, when in an unlocked disposition;

FIG. 4 is an isometric exploded view of the lateral support less its padding;

FIG. 5 is an isometric view showing detail of locking parts of the lateral support;

FIG. 6 is an alternative isometric view showing further detail of the locking components to illustrate their relationship with other parts;

FIG. 7 is a further alternative isometric view of the locking components;

FIG. 8 is an isometric view of the locking parts when unlocked;

FIG. 9 is a further isometric view of the locking parts when unlocked;

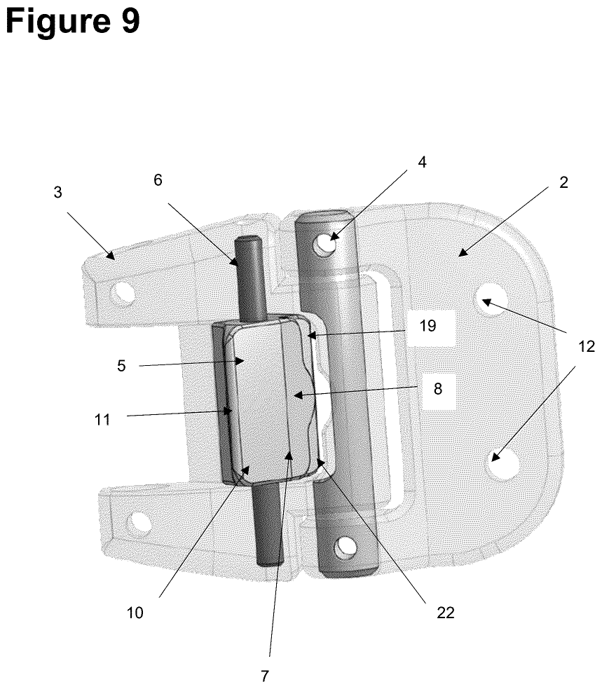

FIG. 10 is a plan view of the lateral support, less its padding, when in the locked disposition; and

FIG. 11 is a plan view of the lateral support, less its padding, when in an unlocked disposition.

### DETAILED DESCRIPTION

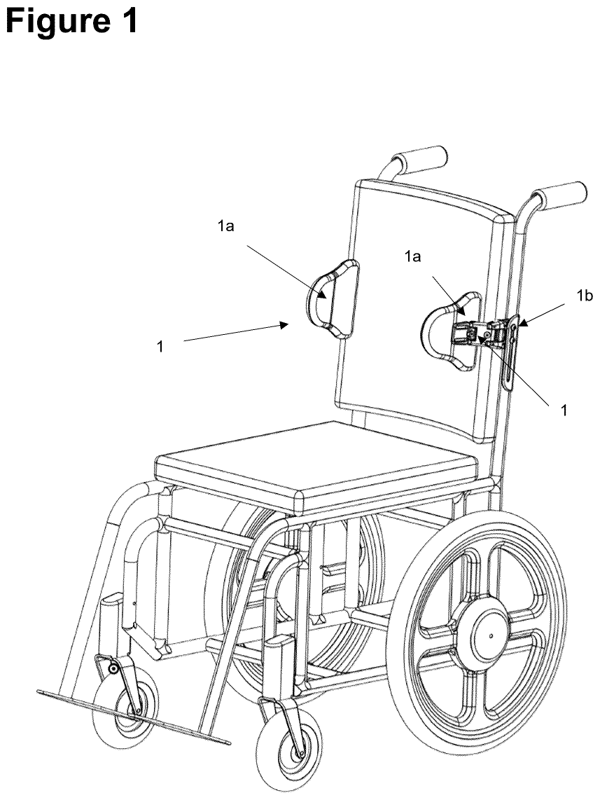

Referring to FIG. 1, the wheelchair is fitted with a lateral support 1 at each side to provide support to the torso of a person with special postural care needs when using the wheelchair. The lateral support incorporates releasable padding 1a which provides for a comfortable point of contact with the wheelchair occupant.

The arrangement is such that each lateral support is fitted to the frame of the wheelchair by way of a bracket 1b, which can be adjustably slid up and down on the frame. This makes the lateral support height adjustable to accommodate people of different sizes.

Each lateral support can be pivoted inwards to make contact with the torso of wheelchair occupant and locked there. However, they can each be subsequently unlocked and pivoted outwards to make more space for the occupant to exit or enter the wheelchair.

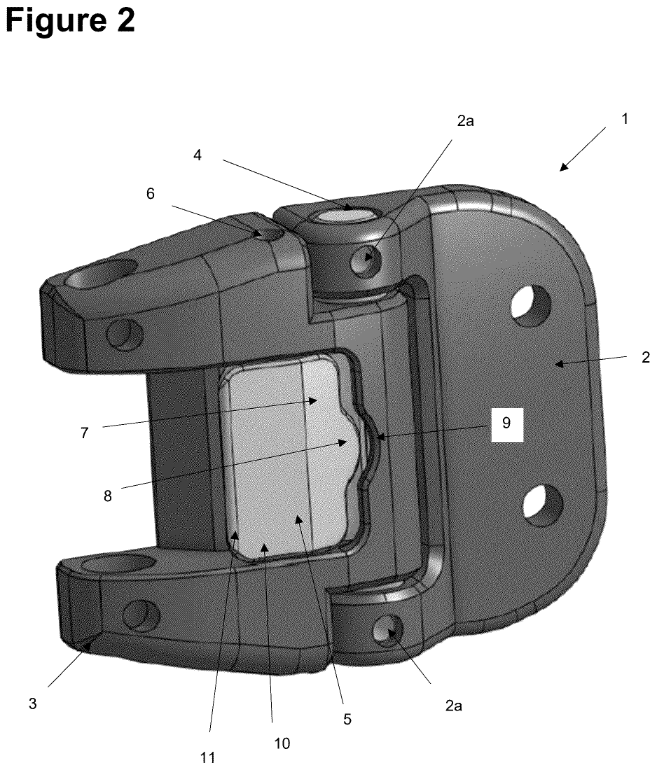

Referring to FIG. 2, the lateral support 1 is in a locked disposition and comprises a hinge plate 2 which is connected to a swivel plate 3 by way of a hinge pin 4. The arrangement is such that the swivel plate 3 can rotate about the hinge pin 4 to change its angle with respect to the hinge plate 2. The hinge pin 4 is retained in the hinge plate by way of pins 2a that sit in aligned lateral holes of the pin 4 and plate 2. The hinge plate is non-rotatably fixed to the bracket 1b.

A release lever 5 is located between the hinge plate 2 and swivel plate 3. The lever 5 is connected to the swivel plate through a swivel pin 6. The arrangement is such that the release lever can rotate around the swivel pin 6 to change its angle with respect to both the hinge plate 2 and swivel plate 3.

The release lever 5 has a first side 7 which incorporates a rounded thumb press 8, which fits into a complementary curved recess 9 of the swivel plate 3. The thumb press 8 can be pushed by hand, using one's thumb and/or fingers, to rotate the lever 5 to unlock the lateral support for the sort of pivoting adjustment described for FIG. 1.

Still with FIG. 2, the lever 5 has a second side 10 which incorporates a tapered surface or grip 11. A wheelchair occupant can grasp the grip 11 by hand and cause the lever to rotate to its unlocked disposition.

It will therefore be appreciated that the lever can be moved between its locked and unlocked dispositions by applying hand pressure to any one or both of the thumb press 8 and the grip 11.

Preferably the lever 5 is biased towards its locked disposition by way of a torsion spring (not shown). The arrangement is such that when the lever has been rotated to its unlocked position by hand, and then released, it automatically swings about the swivel pin 6 to return to its locked position.

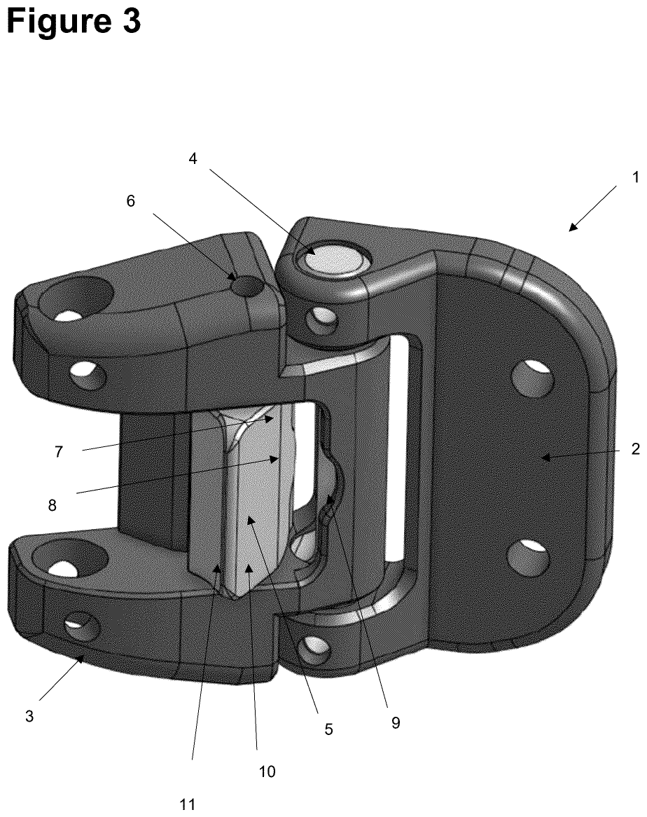

FIG. 3 illustrates the lateral support when in its unlocked disposition, with the lever's thumb press 8 having been pivoted inwards and the hand grip 11 pivoted outwards.

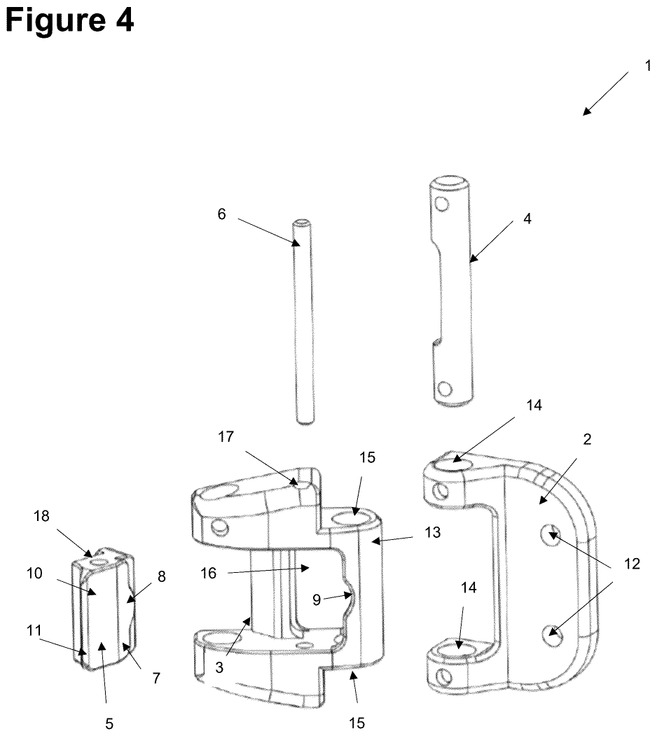

Referring to FIG. 4, the lateral support is illustrated in exploded view. As shown, the hinge plate 2 is generally ‘U’ shaped and has aligned bolt holes 12 for engaging the wheelchair's bracket 1b mentioned for FIG. 1. The hinge plate 2 is formed to fit snugly around a complimentary end 13 of the swivel plate 3 and is retained there by the hinge pin 4, which passes through aligned holes 14 and 15 of the hinge plate 2.

The release lever 5 sits in a central space 16 within the swivel plate 3 and is retained there by the swivel pin 6 which passes through holes 17 and 18 of the swivel plate.

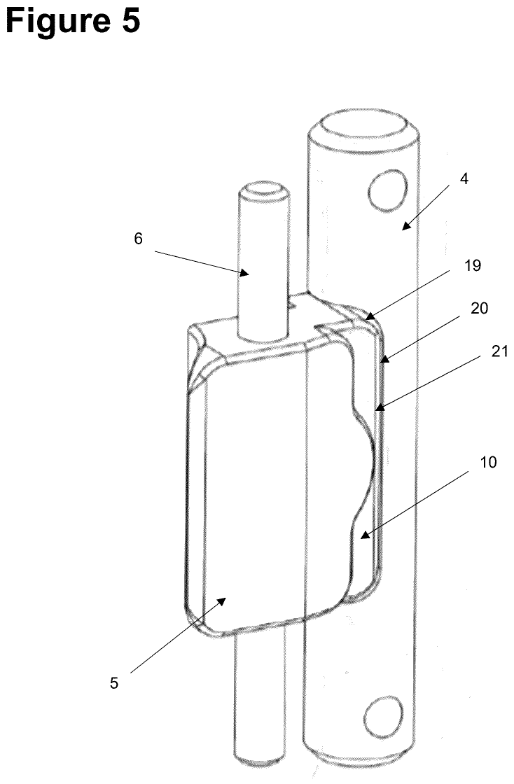

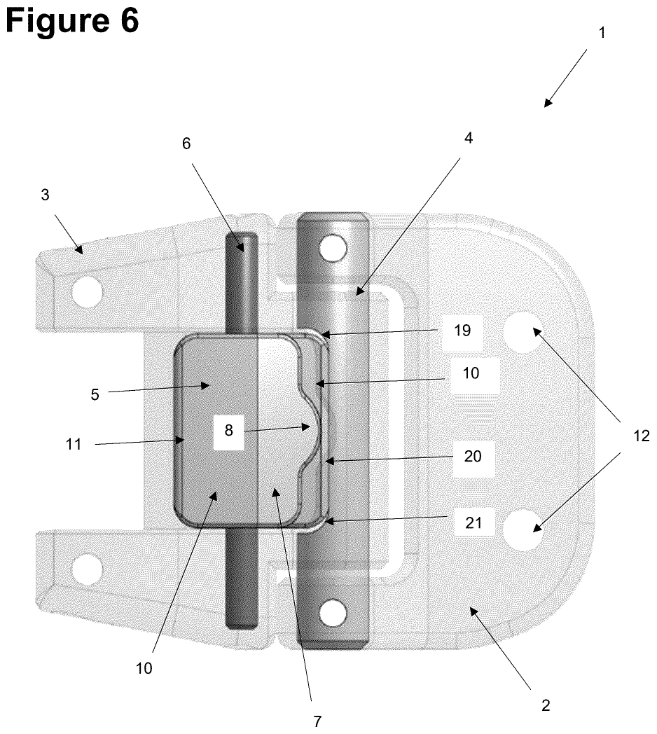

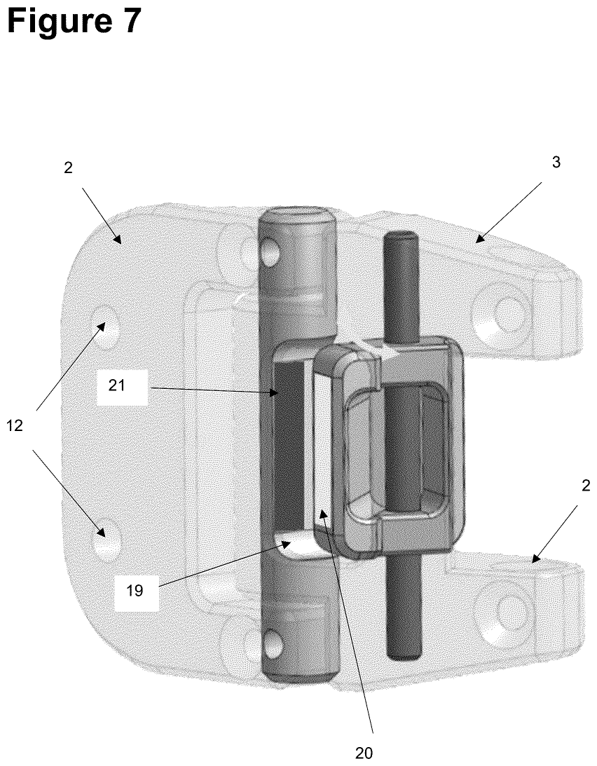

FIGS. 5, 6 & 7 illustrate detail of the hinge pin 4, the release lever 5 and the swivel pin 6 when the lateral support is in its locked disposition. The right hand side of the release lever 5 fits snugly into a recess 19 of the hinge pin 4. With particular reference to FIG. 7, in this position interference surfaces, for example opposing surfaces 20 and 21 of the release lever and the hinge pin, face one another and their most outward edges clash in a rotational impasse. In the example shown, the surfaces 20 and 21 are planar but in other versions they may be non-planar.

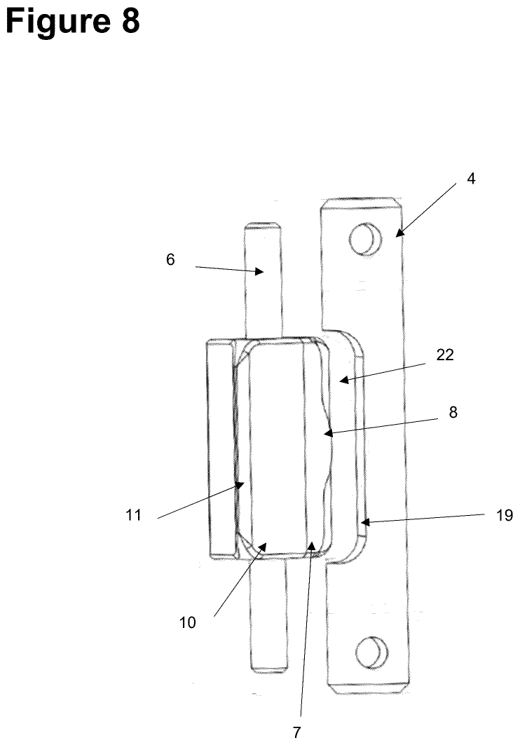

FIGS. 8 & 9 show the release lever 5 when in its unlocked disposition. Again, pushing the thumb press 8, and/or pulling the hand grip 11, results in rotation of the release lever about the swivel pin 6. This moves the right hand side of the release lever inwards, out of the recess 19 to its unlocked position. In this unlocked disposition the swivel plate 3 can pivot with respect to the hinge plate 2, to adjust the angle of the lateral support 1.

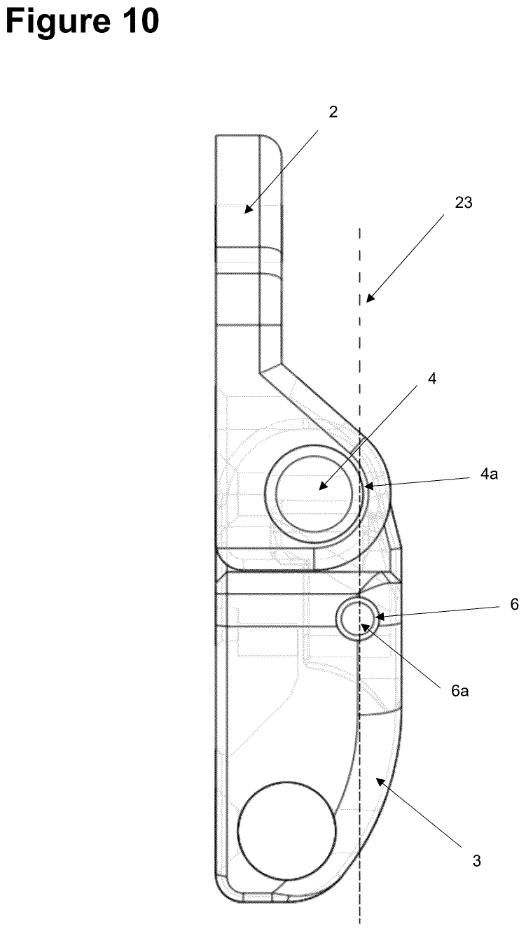

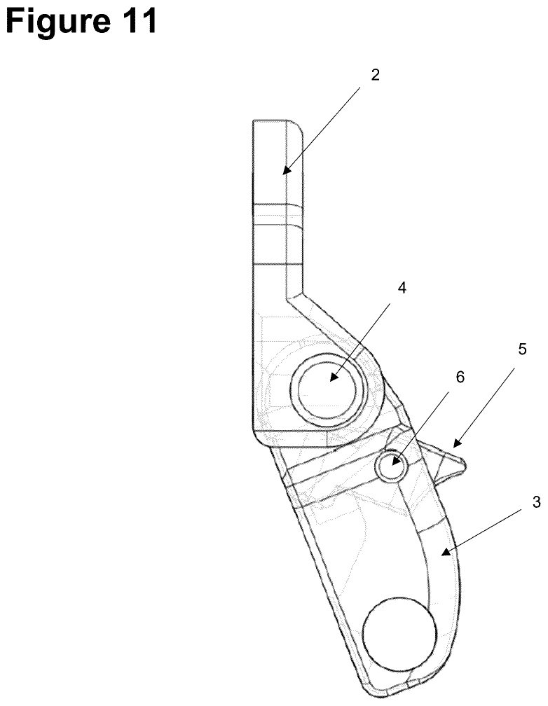

FIGS. 10 and 11 show the lateral support in plan view when in its locked and unlocked positions respectively.

As illustrated in FIG. 10 by broken line 23, the central axis 6 a of the swivel pin 6 is arranged to align with the outermost radial edge 4a of the hinge pin 4, or is just inside it, when in the locked disposition. This facilitates the locking impasse between the interference surfaces 20 and 21 mentioned above. In particular, when the release lever 5 (not shown) swings clockwise in FIG. 10, the right hand side of its interference surface 20 clashes with the extreme right hand side of the hinge pin's interference surface 21. Because the swivel pin 6 is outside the hinge pin 4, when force is applied on the swivel plate 3 the release lever 5 remains locked.

While some preferred embodiments of the invention have been described by way of example it should be appreciated that modifications and improvements can occur without departing from the scope of the following claims.

In terms of disclosure, this document hereby discloses each item, feature or step mentioned herein in combination with one or more of any of the other item, feature or step disclosed herein, in each case regardless of whether such combination is claimed.

1. A wheelchair comprising a lateral support adapted to provide postural support to the torso of a person when seated in the wheelchair, the lateral support comprising a hinge plate, a hinge pin, a swivel plate, a swivel pin and a release lever, arranged such that:
the swivel plate is adapted to rotate about the hinge pin with respect to the hinge plate;
the release lever is adapted to rotate about the swivel pin with respect to the swivel plate such that:
an interference surface of the release lever takes up a locking position immediately next to an interference surface of the hinge pin; wherein
in the locking position the two interference surfaces present a rotational impasse with respect to one another; wherein
a first side of the release lever is adapted to be pressed by hand, so as to rotate the lever out of the locking position; and wherein
a second side of the release lever, being opposite said first side, can be pulled by hand to rotate the lever out of the locking position.

2. A wheelchair according to claims 1, wherein the hinge pin and the swivel pin are substantially parallel to one another.

3. A wheelchair according to claim 1, wherein central longitudinal axis of the swivel pin is aligned with, or slightly inside, the most outward edge of the hinge pin such that when the release lever is in the locking position the outer edge of that lever clashes with the hinge pin.

4. A wheelchair according to claim 1, wherein said second side of the lever is adapted to be pressed by hand and so moved with respect to the swivel plate to rotate the lever into the locking position.

5. A wheelchair according to claim 1, wherein the interference surface of the hinge pin comprises a recess extending longitudinally along that pin and the interference surface of the release lever fits snugly within said recess.

6. A wheelchair according to claim 5, wherein the recess is substantially planar.

7. A wheelchair according to claim 1, wherein the hinge plate is generally ‘U’ shaped.

8. A wheelchair according to claim 1 wherein the release lever has a rounded protrusion that is adapted to fit into a complementary curved recess of the swivel plate immediately adjacent to the hinge pin, the protrusion providing a finger or thumb button surface arranged such that, when pressed by hand, the lever moves out of its locking position.

9. A wheelchair according to claim 1 wherein the hinge plate is fixed such that it does not rotate, rather the swivel plate is rotatable with respect to it.

10. A wheelchair according to claim 1, wherein the release lever incorporates a spring which biases that lever towards the locking position.

11. A wheelchair according to claim 1, wherein:
the hinge pin and the swivel pin are substantially parallel to one another;
a central longitudinal axis of the swivel pin is aligned with, or slightly inside, the most outward edge of the hinge pin such that when the release lever is in the locking position the outer edge of that lever clashes with the hinge pin;
the second side of the lever is adapted to be pressed by hand and so moved with respect to the swivel plate to rotate the lever into the locking position;
the interference surface of the hinge pin comprises a recess extending longitudinally along that pin and the interference surface of the release lever fits snugly within said recess;
the recess is substantially planar;
the hinge plate is generally ‘U’ shaped;
the release lever has a rounded protrusion that is adapted to fit into a complementary curved recess of the swivel plate immediately adjacent to the hinge pin, the protrusion providing a finger or thumb button surface arranged such that, when pressed by hand, the lever moves out of its locking position;
the hinge plate is fixed such that it does not rotate, rather the swivel plate is rotatable with respect to it; and
the release lever incorporates a spring which biases that lever towards the locking position.
